(19) United States
(12) Patent Application Publication
(10) Pub. No.: US 2024/0010034 A1
(43) Pub. Date: Jan. 11, 2024

(54) Trailer Hitching Assist Device

(71) Applicant: Orville Lind, Wasilla, AK (US)

(72) Inventor: Orville Lind, Wasilla, AK (US)

(21) Appl. No.: 17/860,849

(22) Filed: Jul. 8, 2022

(51) Int. Cl. B60D 1/07; B60D 1/02; B60D 1/52

(52) U.S. Cl. CPC B60D 1/075; B60D 1/025; B60D 1/52

(57) ABSTRACT

A trailer hitching assist device for facilitating the hitching of a trailer to a trailer hitch includes a hollow tube with a hitch ball receiver and a hitch ball latch which are configured to cooperatively secure the tube to a hitch ball. A flared member at the end of the tube flares from the tube to an opening. A trailer tongue member is configured for attaching to a trailer frame, an insertion member extends from said trailer tongue member and is insertable into said tube through said opening. When the insertion member is positioned in a locking position, a locking pin is inserted through holes in the tube and the insertion member, thereby securing the insertion member to the tube.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to trailer hitch devices and more particularly pertains to a new trailer hitch device for facilitating the hitching of a trailer to a trailer hitch.

### (2) Description of Related Art including information disclosed under 37 CFR 1.97 and 1.98

The prior art relates to trailer hitch devices which incorporate a means of coupling a trailer to the hitch receiver of an automobile alternative to a traditional ball hitch connection in the hopes of making the process of hitching easier. Several of these devices use mechanisms comprising an inserting member being received into a receiving member. Of these devices, at least two examples make use of a winch system to urge the inserting member into the receiving member and guide the inserting member accordingly. Another pair of devices, the ones disclosed in U.S. Pat. Nos. 4,844,497 and 10,252,588 B2, use receiving members that flare open in an effort to make adjustments to minor misalignments in coupling the two components. However, both of these devices require connecting a different mechanism to the hitch receiver of the automobile. What is missing from the prior art is a mechanism which uses an inserting member that is received into a receiving member, the receiving member having a flared opening to correct misalignments, and which is adaptable to a hitch ball to facilitate efficient alternating between different trailers. Also disclosed in the present invention which is missing in the prior art is a visual alignment means to facilitate the alignment of the inserting and receiving members.

### BRIEF SUMMARY OF THE INVENTION

An embodiment of the disclosure meets the needs presented above by generally comprising a hollow tube with a hitch ball receiver and a hitch ball latch which are configured to cooperatively secure the tube to a hitch ball. A flared member at the end of the tube flares from the tube to an opening. A trailer tongue member is configured for attaching to a trailer frame, an insertion member extends from said trailer tongue member and is insertable into said tube through said opening. When the insertion member is positioned in a locking position, a locking pin is inserted through holes in the tube and the insertion member, thereby securing the insertion member to the tube.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded in-use view of a trailer hitching assist device according to an embodiment of the disclosure.

FIG. 2 is a side view of an embodiment of the disclosure.

FIG. 3 is a top front side perspective view of an embodiment of the disclosure.

### DETAILED DESCRIPTION OF THE INVENTION

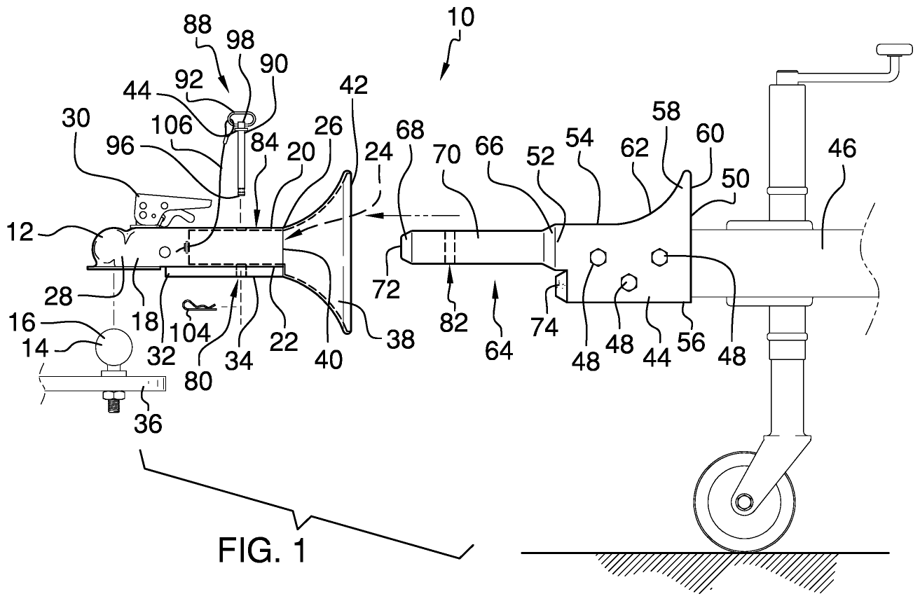

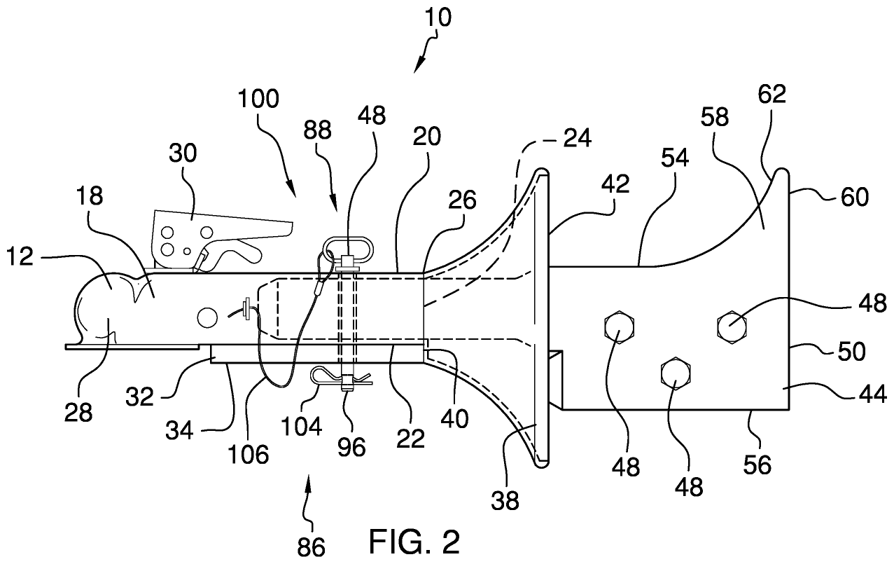

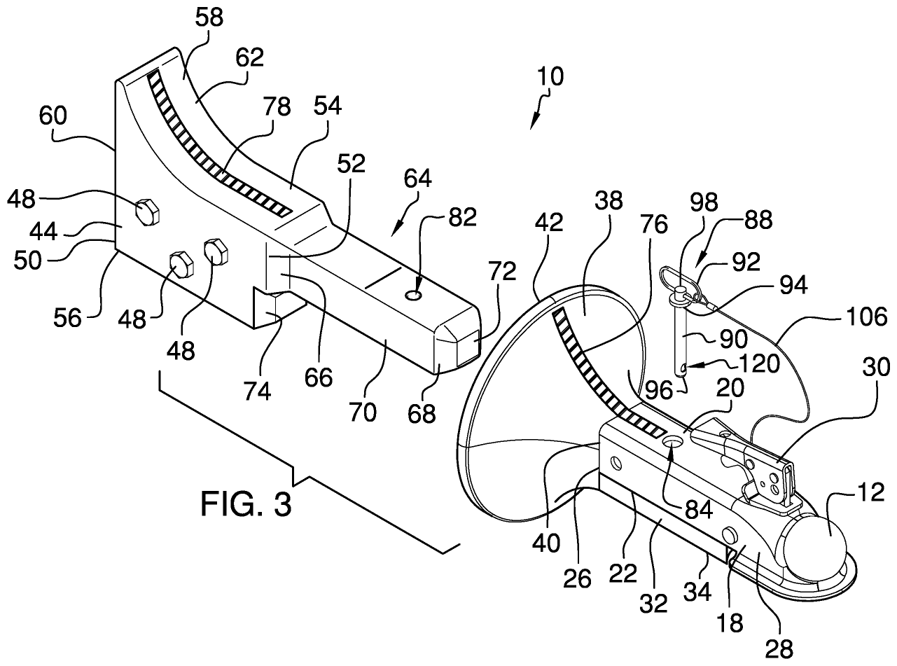

With reference now to the drawings, and in particular to FIGS. 1 through 3 thereof, a new trailer hitch device embodying the principles and concepts of an embodiment of the disclosure and generally designated by the reference numeral 10 will be described.

As best illustrated in FIGS. 1 through 3, the trailer hitching assist device 10 generally comprises a hitch ball receiver 12 which is configured to be complementary in shape to a part of a spherical surface 14 of a hitch ball 16 and to receive the hitch ball 16 therethrough, thereby covering the part of the spherical surface 14 of the hitch ball 16. A hollow tube 18 is coupled to the hitch ball receiver 12 and is elongated along a central longitudinal axis of the tube 18. The tube 18 has a pair of lateral sides 28, a top side 20, and a bottom side 22 opposite the top side 20. The top side 20 of the tube 18 and the bottom side 22 of the tube 18 extend between said pair of lateral sides 28 of said tube 18. The tube also has an aperture 24 in a distal end 26 of the tube 18 relative to the hitch ball receiver 12, the distal end 26 of the tube 18 extending between said pair of lateral sides 28 of said tube 18 and between said top side 20 of said tube 18 and said bottom side 22 of said tube 18. A hitch ball latch 30 is coupled to the tube 18. The hitch ball latch 30 and the hitch ball receiver 12 are configured for cooperatively clamping the hitch ball 16, thereby securing the tube 18 to the hitch ball 16.

A plate 32 is coupled to the bottom side 22 of the tube 18, and the plate 32 has a bottom side 34 away from the tube 18. The plate 32 extends between the pair of lateral sides 28 of the tube 18 and is configured for extending from the distal end 26 of the tube 18 to a hitch plate 36 when the hitch ball receiver 12 receives the hitch ball 16. A flared member 38 is coupled to the distal end 26 of the tube 18 and extends from a proximal end of the flared member 38 relative to the tube 18 to a distal end 42 of the flared member 38 relative to the tube 18. The flared member 38 flares from the proximal end 40 of the flared member 38 to the distal end 42 of the flared member 38. The flared member 38 is hollow and has an opening at the distal end 42 of the flared member 38. The flared member 38 extends from the bottom side 34 of the plate 32 to the top side 20 of the tube 18 and between the lateral sides 28 of the tube 18 at the proximal end 40 of the flared member 38. The flared member 38 has a circular cross section at the distal end 42 of the flared member 38.

A trailer tongue member 44 is configured for coupling to a trailer frame 46 by means of a plurality of fasteners 48 extending through the trailer tongue member 44 and the trailer frame 46. The trailer tongue member 44 has a proximal end 50 relative to the trailer frame 46 and a distal end 52 relative to the trailer frame 46. The trailer tongue member 44 also has a top surface 54 extending from the proximal end 50 of the trailer tongue member 44 to the distal end 52 of the trailer tongue member 44 and a bottom surface 56 opposite the top surface 54 of the trailer tongue member 44. An alignment member 58 extends from the top surface 54 of the trailer tongue member 44 adjacent the proximal end 50 of the trailer tongue member 44. The alignment member 58 has a first surface 60 aligning with the proximal end 50 of the trailer tongue member 44 and a second surface 62, which is a concave curved surface extending from the first surface 60 to the top surface 54 of the trailer tongue member 44. The second surface 62 tangentially meets the top surface 54 of the trailer tongue member 44.

An insertion member 64 extends from the distal end 52 of the trailer tongue member 44 adjacent the top surface 54 of the trailer tongue member 44, along a central longitudinal axis of the insertion member 64. The insertion member 64 has a square cross section and is insertable into the tube 18. The insertion member 64 has a proximal section 66 relative to the trailer tongue member 44, a distal section 68 relative to the trailer tongue member 44, and a middle section 70 extending between the proximal section 66 and the distal section 68. The proximal section 66 tapers from the trailer tongue member 44 to the middle section 70, the middle section 70 is complementary in shape to the tube 18, and the distal section 68 tapers from the middle section 70 to a distal end 72 of the insertion member 64 relative to the trailer tongue member 44. A bumper 74 protrudes from the trailer tongue member 44 adjacent the bottom surface 56 of the trailer tongue member 44, tapering away from the trailer tongue member 44. The bumper 74 is constructed of a resiliently compressible material.

A tube hole 84 perpendicular to the central longitudinal axis of the tube 18 extends through the top side 20 of the tube 18 to the bottom side 22 of the tube 18. A first indicator 78 of a pair of indicators is aligned with the central longitudinal axis of the tube 18 and is coupled to the flared member 38 and the top side 20 of the tube 18. The first indicator 78 extends from the distal end 42 of the flared member 38 to the tube hole 84. A second indicator 80 of the pair of indicators is aligned with the central longitudinal axis of the insertion member 64 and extends along the top surface 54 of the trailer tongue member 44 and the second surface 62 of the alignment member 58. The pair of indicators is constructed of a reflective material and visually indicates a relative angle between the tube 18 and the insertion member 64.

A plate hole 80 extends through the plate 32 and aligns with the tube hole 84. An insertion member hole 82 extends through the middle section 70 of the insertion member 64. The insertion member hole 82 aligns with the tube hole 84 when the insertion member 64 is in a locking position 86. A locking pin 88 is insertable in an insertion position 100 through the tube hole 84, the insertion member hole 82, and the plate hole when the insertion member 64 is in the locking position 86, thereby securing the insertion member 64 to the tube 18.

The locking pin 88 has a pin section 90, a ring section 92, and a collar section 94. The pin section 90 has a first end 96 and a second end 98. The ring section 92 extends laterally through the pin section 90 proximate the first end 96 of the pin section 90. The collar section 94 is circumferentially coupled to the pin section 90 proximate the ring section 92 and engages the tube 18 when the locking pin 88 is in the insertion position 100. The locking pin 88 defines a pin hole 102 extending laterally through the pin section 90 proximate the second end 98 of the pin section 90. A hairpin cotter pin 104 is positionable such that the hairpin cotter pin 104 inserts through the pin hole 102 and clips to the locking pin 88 when the locking pin 88 is in the insertion position 100, thereby securing the locking pin 88 to the tube 18. A line 106 couples the ring section 92 of the locking pin 88 to the tube 18.

In use, with the hitch receiver and the hitch latch securely clamped to the hitch ball 16 and the trailer tongue member 44 being coupled to the trailer frame 46, a vehicle to which the hitch ball 16 is coupled reverses to receive the insertion member 64 into the tube 18. The flared member 38 facilitates minor adjustments in positioning the tube 18 relative to the insertion member 64. If the vehicle has a backup camera, the driver of the vehicle may also visually determine the relative angle between the tube 18 and the insertion member 64 and correct course accordingly. Once the insertion member 64 is in the locking position 86, the locking pin 88 is inserted into said tube hole 84, the insertion member hole 82, and the plate hole 80 to secure the insertion member 64 to the tube 18. Then the hairpin cotter pin 104 is inserted into the pin hole 102 and clipped to the locking pin 88 to secure the locking pin 88 to the tube 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A trailer hitching assist device comprising:
a hitch ball receiver, said hitch ball receiver being configured for receiving a hitch ball therethrough, thereby covering a part of a spherical surface of the hitch ball;
a tube, said tube being coupled to the hitch ball receiver, said tube being elongated along a central longitudinal axis of said tube, said tube being hollow, said tube having a pair of lateral sides, said tube having a top side and a bottom side opposite said top side, each of said top side of said tube and said bottom side of said tube extending between said pair of lateral sides, said tube having an aperture in a distal end of said tube relative to said hitch ball receiver, said distal end of said tube extending between said pair of lateral sides of said tube and between said top side of said tube and said bottom side of said tube;
a hitch ball latch, said hitch ball latch being coupled to said tube, said hitch ball latch and said hitch ball receiver being configured for cooperatively clamping the hitch ball, thereby securing said tube to the hitch ball;
a flared member, said flared member being coupled to said distal end of said tube, said flared member extending from a proximal end of said flared member relative to said tube to a distal end of said flared member relative to said tube, said flared member flaring from said proximal end of said flared member to said distal end of said flared member, said flared member being hollow and having an opening at said distal end of said flared member;
a trailer tongue member, said trailer tongue member being configured for coupling to a trailer frame, said trailer tongue member having a proximal end relative to the trailer frame and a distal end relative to the trailer frame, said trailer tongue member having a top surface extending from said proximal end of said trailer tongue member to said distal end of said trailer tongue member, said trailer tongue member having a bottom surface opposite said top surface of said trailer tongue member;
an insertion member, said insertion member extending from said distal end of said trailer tongue member, said insertion member extending along a central longitudinal axis of said insertion member, said insertion member having a square cross section, wherein said insertion member is insertable into said tube;
a tube hole, said tube hole extending through said top side of said tube to said bottom side of said tube, said hole being perpendicular to said central longitudinal axis of said tube;
an insertion member hole, said insertion member hole extending through said top surface of said insertion member to said bottom surface of said insertion member, said insertion member hole aligning with said tube hole when said insertion member is in a locking position; and
a locking pin, said locking pin being insertable in an insertion position through said tube hole and said insertion member hole when said insertion member is in said locking position, thereby securing said insertion member to said tube.

2. The device of claim 1, further comprising said hitch ball receiver being configured to be complementary in shape to a part of a spherical surface of a hitch ball.

3. The device of claim 1, further comprising:
a plate, said plate being coupled to said bottom side of said tube, said plate having a bottom side facing away from said tube, said plate extending between said pair of lateral sides of said tube, said plate being configured for extending from said distal end of said tube to a hitch plate when said hitch ball receiver receives the hitch ball, said flared member extending from said bottom side of said plate to said top side of said tube and between said lateral sides of said tube at said proximal end of said flared member; and
a plate hole, said plate hole extending through said plate and aligning with said tube hole,
said locking pin being insertable in an insertion position through said tube hole, said insertion member hole, and said plate hole when said insertion member is in said locking position, thereby securing said insertion member to said tube.

4. The device of claim 3, further comprising said flared member having a circular cross section at said distal end of said flared member. The device of claim 1, further comprising said trailer tongue member being configured for coupling to a trailer frame by means of a plurality of fasteners extending through said trailer tongue member and the trailer frame.

6. The device of claim 1, further comprising an alignment member, said alignment member extending from said top surface of said trailer tongue member.

7. The device of claim 6, further comprising said alignment member being adjacent said proximal end of said trailer tongue member, said alignment member having a first surface and a second surface, said first surface aligning with said proximal end of said trailer tongue member, said second surface being a concave curved surface extending from said first surface to said top surface of said trailer tongue member, said second surface tangentially meeting said top surface of said trailer tongue member;

8. The device of claim 1, further comprising said insertion member being adjacent said top surface of said trailer tongue member.

9. The device of claim 1, further comprising said insertion member having a proximal section relative to said trailer tongue member, a distal section relative to said trailer tongue member, and a middle section extending between said proximal section and said distal section, said proximal section tapering from said trailer tongue member to said middle section, said middle section being complementary in shape to said tube, said distal section tapering from said middle section to a distal end of said insertion member relative to said trailer tongue member, said insertion member hole extending through said middle section of said insertion member.

10. The device of claim 1, further comprising a bumper, said bumper protruding from said trailer tongue member adjacent said bottom surface of said trailer tongue member.

11. The device of claim 10, further comprising said bumper tapering away from said trailer tongue member, said bumper being constructed of a resiliently compressible material.

12. The device of claim 1, further comprising a pair of indicators, a first indicator of said pair of indicators being coupled to a top surface of said flared member, said top surface of said flared member facing upward when said hitch ball receiver receives the hitch ball therethrough, said first indicator being aligned with said central longitudinal axis of said tube, a second indicator of said pair of indicators being coupled to a top surface of said alignment member, said top surface of said alignment member facing upward when said trailer tongue member is coupled to the trailer frame, said second indicator being aligned with said central longitudinal axis of said insertion member, said pair of indicators visually indicating a relative angle between said tube and said insertion member.

13. The device of claim 7, further comprising a pair of indicators, a first indicator of said pair of indicators being coupled to said flared member and said top side of said tube, said first indicator being aligned with said central longitudinal axis of said tube, said first indicator extending from said distal end of said flared member to said tube hole, a second indicator of said pair of indicators extending along said top surface of said trailer tongue member and said second surface of said alignment member, said second indicator being aligned with said central longitudinal axis of said insertion member, said pair of indicators visually indicating a relative angle between said tube and said insertion member.

14. The device of claim 12, further comprising said pair of indicators being constructed of a reflective material.

15. The device of claim 13, further comprising said pair of indicators being constructed of a reflective material.

16. The device of claim 1, further comprising said locking pin having a pin section, a ring section, and a collar section, said pin section having a first end and a second end, said ring section extending laterally through said pin section proximate said first end of said pin section, said collar section being circumferentially coupled to said pin section proximate said ring section, wherein said collar section engages said tube when said locking pin is in said insertion position, said locking pin defining a pin hole extending laterally through said pin section proximate said second end of said pin section;
a hairpin cotter pin, said hairpin cotter pin being positionable such that said hairpin cotter pin inserts through said pin hole and clips to said locking pin when said locking pin is in said insertion position, thereby securing said locking pin to said tube; and
a line, said line coupling said ring section of said locking pin to said tube.

17. A trailer hitching assist device comprising:
a hitch ball receiver, said hitch ball receiver being configured to be complementary in shape to a part of a spherical surface of a hitch ball, said hitch ball receiver being configured for receiving a hitch ball therethrough, thereby covering the part of the spherical surface of the hitch ball;
a tube, said tube being coupled to the hitch ball receiver, said tube being elongated along a central longitudinal axis of said tube, said tube being hollow, said tube having a pair of lateral sides, said tube having a top side and a bottom side opposite said top side, each of said top side of said tube and said bottom side of said tube extending between said pair of lateral sides, said tube having an aperture in a distal end of said tube relative to said hitch ball receiver, said distal end of said tube extending between said pair of lateral sides of said tube and between said top side of said tube and said bottom side of said tube;
a hitch ball latch, said hitch ball latch being coupled to said tube, said hitch ball latch and said hitch ball receiver being configured for cooperatively clamping the hitch ball, thereby securing said tube to the hitch ball;
a plate, said plate being coupled to said bottom side of said tube, said plate having a bottom side facing away from said tube, said plate extending between said pair of lateral sides of said tube, said plate being configured for extending from said distal end of said tube to a hitch plate when said hitch ball receiver receives the hitch ball;
a flared member, said flared member being coupled to said distal end of said tube, said flared member extending from a proximal end of said flared member relative to said tube to a distal end of said flared member relative to said tube, said flared member flaring from said proximal end of said flared member to said distal end of said flared member, said flared member being hollow and having an opening at said distal end of said flared member, said flared member extending from said bottom side of said plate to said top side of said tube and between said lateral sides of said tube at said proximal end of said flared member, said flared member having a circular cross section at said distal end of said flared member;
a trailer tongue member, said trailer tongue member being configured for coupling to a trailer frame by means of a plurality of fasteners extending through said trailer tongue member and the trailer frame, said trailer tongue member having a proximal end relative to the trailer frame and a distal end relative to the trailer frame, said trailer tongue member having a top surface extending from said proximal end of said trailer tongue member to said distal end of said trailer tongue member, said trailer tongue member having a bottom surface opposite said top surface of said trailer tongue member;
an alignment member, said alignment member extending from said top surface of said trailer tongue member adjacent said proximal end of said trailer tongue member, said alignment member having a first surface and a second surface, said first surface aligning with said proximal end of said trailer tongue member, said second surface being a concave curved surface extending from said first surface to said top surface of said trailer tongue member, said second surface tangentially meeting said top surface of said trailer tongue member;
an insertion member, said insertion member extending from said distal end of said trailer tongue member adjacent said top surface of said trailer tongue member, said insertion member extending along a central longitudinal axis of said insertion member, said insertion member having a square cross section, said insertion member having a proximal section relative to said trailer tongue member, a distal section relative to said trailer tongue member, and a middle section extending between said proximal section and said distal section, said proximal section tapering from said trailer tongue member to said middle section, said middle section being complementary in shape to said tube, said distal section tapering from said middle section to a distal end of said insertion member relative to said trailer tongue member, wherein said insertion member is insertable into said tube;
a bumper, said bumper protruding from said trailer tongue member adjacent said bottom surface of said trailer tongue member, said bumper tapering away from said trailer tongue member, said bumper being constructed of a resiliently compressible material;
a tube hole, said tube hole extending through said top side of said tube to said bottom side of said tube, said hole being perpendicular to said central longitudinal axis of said tube;
a pair of indicators, a first indicator of said pair of indicators being coupled to said flared member and said top side of said tube, said first indicator being aligned with said central longitudinal axis of said tube, said first indicator extending from said distal end of said flared member to said tube hole, a second indicator of said pair of indicators extending along said top surface of said trailer tongue member and said second surface of said alignment member, said second indicator being aligned with said central longitudinal axis of said insertion member, said pair of indicators being constructed of a reflective material, said pair of indicators visually indicating a relative angle between said tube and said insertion member;
a plate hole, said plate hole extending through said plate and aligning with said tube hole;
an insertion member hole, said insertion member hole extending through said middle section of said insertion member, said insertion member hole aligning with said tube hole when said insertion member is in a locking position;
a locking pin, said locking pin being insertable in an insertion position through said tube hole, said insertion member hole, and said plate hole when said insertion member is in said locking position, thereby securing said insertion member to said tube, said locking pin having a pin section, a ring section, and a collar section, said pin section having a first end and a second end, said ring section extending laterally through said pin section proximate said first end of said pin section, said collar section being circumferentially coupled to said pin section proximate said ring section, wherein said collar section engages said tube when said locking pin is in said insertion position, said locking pin defining a pin hole extending laterally through said pin section proximate said second end of said pin section;
a hairpin cotter pin, said hairpin cotter pin being positionable such that said hairpin cotter pin inserts through said pin hole and clips to said locking pin when said locking pin is in said insertion position, thereby securing said locking pin to said tube; and
a line, said line coupling said ring section of said locking pin to said tube.
